(19) United States
(12) Patent Application Publication
(10) Pub. No.: US 2006/0232854 A1
(43) Pub. Date: Oct. 19, 2006

(54) Microscope

(75) Inventor: Hiroshi Watanabe, Tokyo (JP)

Correspondence Address: Thomas Spinelli;Scully, Scott, Murphy & Presser, 400 Garden City Plaza, Garden City, NY, 11530, US

(73) Assignee: OLYMPUS CORPORATION, Tokyo (JP)

(21) Appl. No.: 11/393,237

(22) Filed: Mar. 30, 2006

(30) Foreign Application Priority Data
Apr. 14, 2005 (JP) 2005-117153

(51) Int. Cl. G02B 21/00

(52) U.S. Cl. 359/368; 359/388

(57) ABSTRACT

A microscope comprising at least one or more motorized drive units, an operation unit with at least one or more operation switches for operating the motorized drive units, a control unit for controlling the motorized drive units and a setting unit in which the control unit can externally switch the setting of a function to control the motorized drive units can be provided. According to the present invention, even if an observer pushes the operation unit by mistake in a microscope using at least one or more motorized units without using an expensive PC system and a LC display unit, neither motorized unit will be driven nor there will be any observation error.

### CROSS-REFERENCE TO RELATED APPLICATIONS

This application claims benefit of Japanese Application No. 2005-117153, filed Apr. 14, 2005, the contents of which are incorporated by this reference.

### BACKGROUND OF THE INVENTION

1. Field of the Invention

The present invention relates to microscopes used in medical science, biology, industrial usage and the like, microscope units incorporated into inspection devices used in industrial fields, such as semiconductors, liquid crystal and the like, and more particularly relates to a microscope with at least one or more motorized drive unit and an operation unit for operating the motorized drive unit.

2. Description of the Related Art

A microscope is used in a variety of fields, such as medical science, biology, an industrial field and the like for usages for the inspection of IC wafers and magnetic heads, the quality management of metallic structure and the like, the R&D of new materials and the like.

The recent microscope comprises a plurality of motorized drive units represented by a nosepiecenosepiece, a focusing unit, an optical stop, and an observer can operate the motorized drive unit on the operation unit incorporated into the microscope cabinet. The diameter of an optical stop, such as aperture stop and a view field stop, is set for each installed object lens. The optical stop has a preset function to shift to the diameter of predetermined switching destination lens to be automatically to optimal observation conditions for the observer (for example, see Japanese Patent Application Publication No. H8-201701).

In such a microscope, if the observer pushes the button of the microscope operation unit by mistake after each motorized unit shifts to the setting value in conjunction with the switching of the object lens, the motorized unit shifts. More particularly, in the case of an optical stop whose state cannot be confirmed from outside the microscope, if the observer keeping the observation without being aware of having pushed the operation unit during observation by mistake, an inspection error occurs. Even if the observer is ware of having push the operation unit by mistake, the observer must switch to an object lens to be used for the observation again after switching it to another object lens once, which is troublesome.

In order to solve such a conventional problem, a microscope which can be controlled by a personal computer (PC) and whose image obtained by a CCD camera, the driving/no-driving states of the motorized drive unit and the current position information of the optical stop can be displayed on a PC monitor is proposed (for example, see Japanese Patent Application Publication No. 2001-305433).

In such a microscope, control by a PC (remote mode) and control by an operation unit incorporated into a microscope frame (local mode) can be switched over by the PC. The remote and local modes are exclusive to each other, and in the remote mode, the microscope cannot be operated by the PC. In that case, by setting the remote mode and operating the microscope by a software GUI on the PC, the number of errors that an observer pushes the button of the operation unit by mistake during observation can be reduced.

However, there is a tendency to minimize the installation space of each device represented by a microscope in a semiconductor plant, and recently the miniaturization of devices is promoted.

In this case, a PC system is added to the above-described microscope to increase the installation space. If an expensive PC is used, the cost of the entire microscope system increase.

In the case of the local mode, the problem that an observer may push the operation unit by mistake cannot be solved.

In order to such problems, a microscope comprising an operation display unit using a light emitting display member represented by liquid crystal is proposed (for example, see Japanese Patent Application Publication No. 2002-182114). Such a microscope displays the driving/no-driving states of the motorized drive unit and the current position information as character information on a light emitting display member to notify an observer of it.

In this way, if an observer pushes an operation button by mistake, the current position information is displayed on the operation display unit. Therefore, the observer can restore the motorized unit by pushing the operation button.

It is an object of the present invention to provide a microscope in which a motorized unit is prevented from being driven even without using an expensive PC system and a display unit using liquid crystal or the like even if an observer pushes the button of the operation unit by mistake in a microscope using at least one or more motorized drive units.

### SUMMARY OF THE INVENTION

According to one aspect of the present invention, the microscope of the present invention comprises at least one or more motorized drive units, an operation unit with at least one or more operation switches for operating the motorized drive units, a control unit for controlling the motorized drive units and a setting unit in which the control unit can externally switch the setting of a function to control the motorized drive units.

### BRIEF DESCRIPTION OF THE DRAWINGS

The present invention will be more apparent from the following detailed description when the accompanying drawings are referenced.

FIG. 1 shows the basic configuration of a microscope to which the first preferred embodiment is applied;

FIG. 2 shows a piano switch and a rotary switch composing the setting unit;

FIG. 3 shows the structure of a front switch group in the first preferred embodiment;

FIG. 4 shows the structure of a nosepiecenosepiece drive button group and an aperture stop (AS) drive button group;

FIG. 5 shows the configuration of the control unit of the first preferred embodiment;

FIG. 6 shows an example of a preset diameter table in the first preferred embodiment;

FIG. 7 is a flowchart showing the initialization process of a microscope in the first preferred embodiment;

FIG. 8 shows the display state of the front switch group (the nosepiecenosepiece is not connected);

FIG. 9 shows the display state of the front switch group (AS is not connected, AS invalid setting);

FIG. 10 shows the display state of the front switch group (AS is being shifted to open);

FIG. 11 shows the display state of the front switch group (AS is being shifted to close);

FIG. 12 shows the structure of a microscope setting address in RAM;

FIG. 13 shows the display state of the front switch group (idle);

FIG. 14 is a flowchart showing the operation process in the case where the AS drive button group in the first preferred embodiment of the present invention;

FIG. 15 shows the display state of the front switch group (AS position>preset position);

FIG. 16 shows the display state of the front switch group (AS position<preset position);

FIG. 17 is a flowchart showing the nosepiecenosepiece drive process in the first preferred embodiment of the present invention;

FIG. 18 shows the structure of the front switch group in the second preferred embodiment;

FIG. 19 shows an example of an AP preset diameter table in the second preferred embodiment of the present invention;

FIG. 20 is a flowchart showing the initialization process in the second preferred embodiment of the present invention;

FIG. 21 is a flowchart showing the operation process in the case where the setting button group in the second preferred embodiment of the present invention;

FIG. 22 shows the display state of the front switch group (AS invalid setting); and

FIG. 23 shows the display state of the front switch group (AS valid setting).

### DESCRIPTION OF THE PREFERRED EMBODIMENTS

The preferred embodiments of the present invention are described below with reference to the drawings.

Specifically, according to one aspect of the present invention, the microscope of the present invention comprises at least one or more motorized drive units, an operation unit with at least one or more operation switches for operating the motorized drive units, a control unit for controlling the motorized drive units and a setting unit capable of externally switching the setting of a function for the control unit to control the motorized drive units.

It is preferable in the microscope of the present invention for the function set by the setting unit to be a function to validate or invalidate the operation of the operation unit.

It is preferable for the microscope of the present invention to further comprise a light emission unit for emitting light according to a function set by the setting unit, in accordance with the operation switches.

It is preferable in the microscope of the present invention for the light emission unit to enable the light emitting light pattern of an operation switch set invalid by the setting unit and the light emitting light pattern of an operation switch set valid differently light.

It is preferable in the microscope of the present invention for the function set by the setting unit to drive a motorized drive unit operated by the operation unit.

It is preferable in the microscope of the present invention for the motorized drive unit to drive at least one of a nosepiecenosepiece, an AS, an observation method switch, an X-Y stage, a Z stage, an auto-focus (AF), a filter turret, a shutter, a field stop (FS), a condenser lens, a differential interference contrast (DIC) prism and a light control.

It is preferable in the microscope of the present invention for the setting unit to be at least one of a piano switch, rotary switch, a button switch, a lever switch, a toggle switch, a slide switch and a seesaw switch.

According to another aspect of the present invention, the microscope of the present invention comprises at least one or more motorized drive units, an operation unit with at least one or more operation switches for operating the motorized drive units, a control unit for controlling the motorized drive units. The operation unit can switch between a function to validate the operation of the operation unit and a function to invalidate the operation.

It is preferable for the microscope of the present invention to further comprise a light emission unit for enabling a light emitting pattern differently light according to whether the operation unit is switched valid or invalid, in accordance with the operation switches.

It is preferable in the microscope of the present invention for the motorized drive unit to drive at least one of a nosepiecenosepiece, an AS, an observation method switch, an X-Y stage, a Z stage, an auto-focus (AF), a filter turret, a shutter, an field stop (FS), a condenser lens, a DIC prism and a light control.

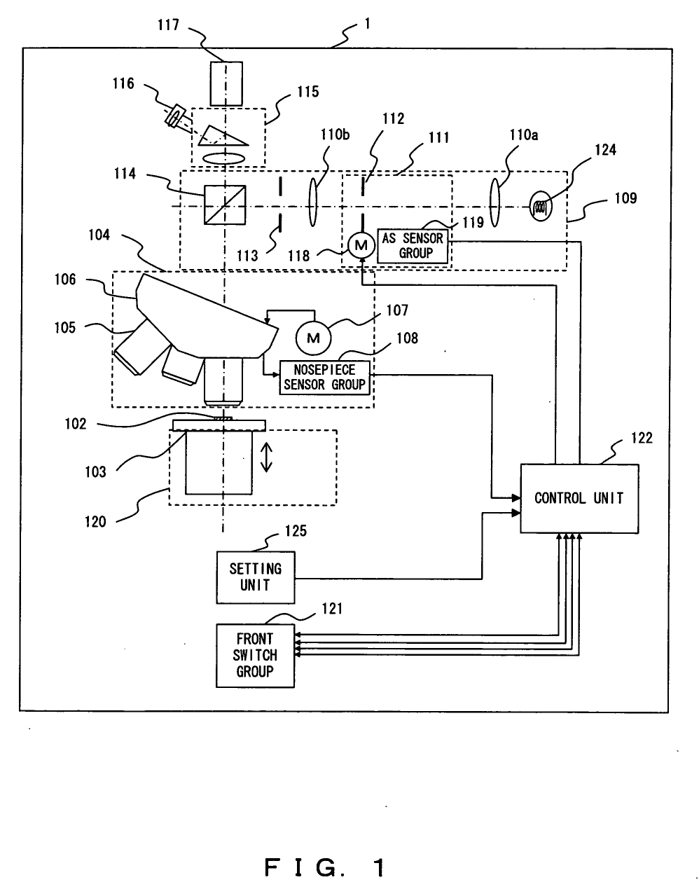

FIG. 1 shows the basic configuration of the microscope to which the first preferred embodiment is applied.

In FIG. 1, a microscope main body 1 comprises a CCD camera 117, a observation tube 115, an illumination unit 109, a nosepiecenosepiece unit 104, a stage 103, a focusing unit 120, a setting unit 125, a front switch group 121 and a control unit 122.

In the microscope main body 1, the nosepiecenosepiece unit 104 is disposed opposite to the stage 103 which can mount a specimen 102. This nosepiecenosepiece unit 104 can mount up to six object lens at the maximum, and numbers #1-6 are assigned to object lens mounting moles, which are not shown in FIG. 1. The nosepiecenosepiece unit 104 comprises a mounter 106 for mounting an object lens 105, a nosepiecenosepiece motor 107 for driving the mounter 106 and a nosepiecenosepiece sensor group 108. The nosepiecenosepiece sensor group 108 comprises a nosepiecenosepiece connection sensor for detecting that the nosepiecenosepiece unit 104 is connected to the microscope main body 1, which is not shown in FIG. 1, a hole number sensor for detecting the current hole number and a movement completion sensor for detecting the object lens 105 is inserted in an optical axis.

The illumination unit 109 comprises a microscope light source 124 for illuminating the specimen 102. After light from the microscope light source 124 is collected at the aperture unit 112 of the aperture stop (AS) unit 111 by an illumination lens 110a, passes through a field stop (FS) 113 by the illumination lens 110b and is led to a half mirror 114. Then, the light whose direction is turned by 90 degrees by the half mirror 114 passes through the object lens 105 and is illuminated to the specimen 102. After the light reflected by the specimen 102 passes through the object lens 105, it is transmitted through the half mirror 114 and is led to the observation tube 115. Thus, an observer can observe an image obtained by an eyepieace lens 116 or the CCD camera 117 via a PC monitor, which is not shown in FIG. 1.

The AS unit 111 is disposed on an optical axis, and is used to adjust the luminance and contrast of the image of the specimen 102. The AS unit 111 comprises an aperture unit 112, an AS motor 118 for motorizedly opening/shutting the aperture unit 112 and an AS sensor group 119. The AS sensor group 119 comprises an AS connection sensor for detecting that the AS unit 111 is connected, which is not shown in FIG. 1 and an origin sensor for detecting the original position of the AS motor 118.

Since the opening hole diameter of the aperture unit of the AS unit 111, optimally suitable for observation differs depending on the object lens 105, the AS unit 111 is provided with a function to enable the aperture unit adjust to a preset diameter according to an object lens switched receiving an instruction to switch an object lens (AS preset function).

The stage 103 is used to mount a specimen 102 and can be moved in the X-Y direction. The stage 103 is mounted on the focusing unit 120 which can be move in the Z direction. By moving the focusing unit 120, an observer can focus the object lens 105 on a specimen 102.

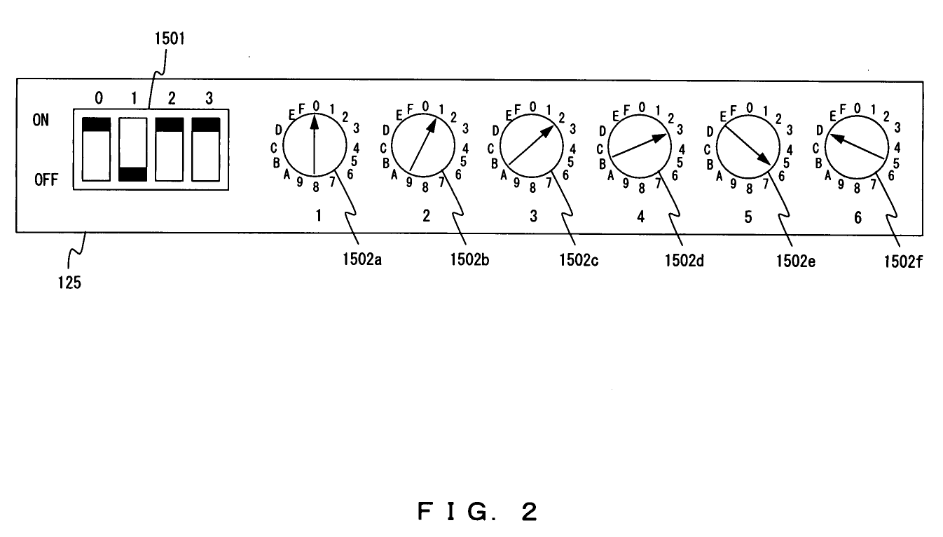

As shown in FIG. 2, the setting unit 125 comprises a piano switch 1501, six rotary switches 1502a, 1502b, 1502c, 1502d, 1502e and 1502f.

The piano switch 1501 is a four-bits switch and performs each setting of the microscope main body 1. In this preferred embodiment, the valid/invalid setting of an AS drive button and AS preset ON/OFF setting are assigned to the BIT 1 and BIT2, respectively, of the piano switch 1501.

Each of the rotary switches 1502a, 1502b, 1502c, 1502d, 1502e and 1502f is a 16-bits switch, the same number of switches as the holes are provided. The AS preset position setting of the first hole is assigned to the rotary switch 1502a. Similarly, the AS preset position settings of the second through sixth hole are assigned to the rotary switches 1502b through 1502f, respectively.

The front switch group 121 is provided for an observer to operate nosepiece unit 104 and the AS unit 111, which are the motorized of the microscope main body 1.

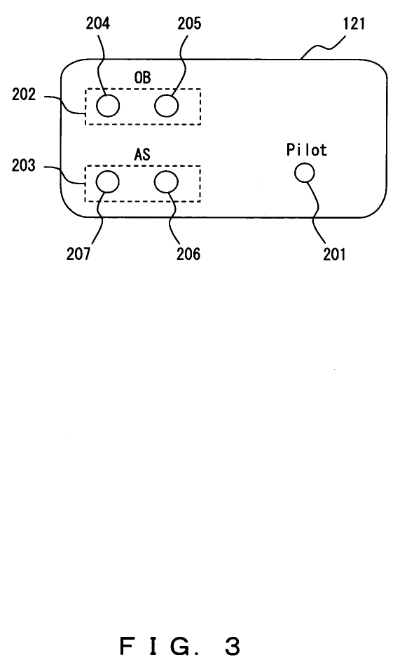

FIG. 3 shows the structure of the front switch group in the first preferred embodiment.

The front switch group 121 comprises a pilot lamp 201 for indicating the “on” state of the power of the microscope main body 1, a nosepiece drive button group 202 for rotating the mounter 106 of the nosepiece unit 104 clockwise (CW) or counterclockwise (CCW) and an AS drive button group for opening/shutting the aperture unit 112 of the AS unit 111. The nosepiece drive button group 202 comprises a CW button 204 and a CCW button 205. If the CW button 204 or CCW button 205 is pushed once, the mounter is rotated.

The AS drive button group 203 comprises an open button 206 and a shut button 207. While the button is pushed, the aperture unit 112 is driven and if it is released, the drive is stopped.

Both the AS drive button group 203 and the nosepiece drive button group 202 are disposed in such a way that an observer can easily operate them. The buttons are also disposed at front of the microscope main body 1 in such a way that the observer can access them while operating the handle of the focusing unit 120, which is not shown in FIG. 3.

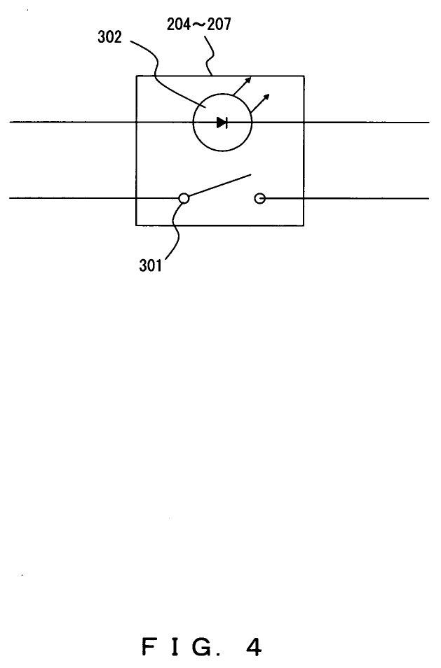

FIG. 4 shows the respective structures of each of the nosepiece drive button group and AS drive button group.

As shown in FIG. 4, each button of the nosepiece drive button group 202 and AS drive button group 203 is composed of one package of a switch 301 and a light emitting diode (LED) 302, patterns, such as lighting, extinguishing, flashing and the other are assigned according to the state of the microscope main body, such as drive, status, error and the like to also indicate them.

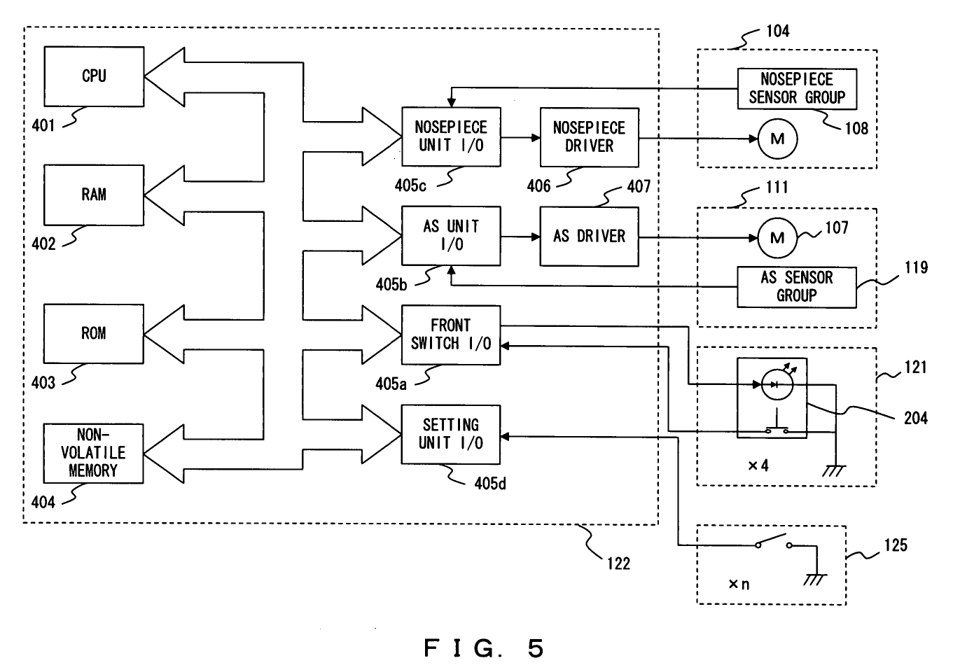

FIG. 5 shows the configuration of the control unit of the first preferred embodiment.

As shown in FIG. 5, the control unit 122 comprises a CPU 401, RAM 402 for storing data such as operation data, etc., RAM 403 for storing the control program, etc., non-volatile memory 404 for storing AS preset diameters for each object lens 105, etc., an AS unit I/O 405b for controlling the AS unit 111, I/O 405c for controlling the nosepiece unit 104, a setting unit I/O 405d for controlling the switching of the setting unit 125, a front switch I/O 405 a being the input/output of the front switch group 121, a nosepiece driver 406 for driving the nosepiece motor 107 and an AS driver 407 for driving the motor of the AS unit 111 and also counting the current position.

In order to light the LED of the front switch group, an “H” signal is transmitted to an address corresponding to each button of the front switch I/O 405a. Similarly, in order to extinguish it, an “L” signal is transmitted to the same address.

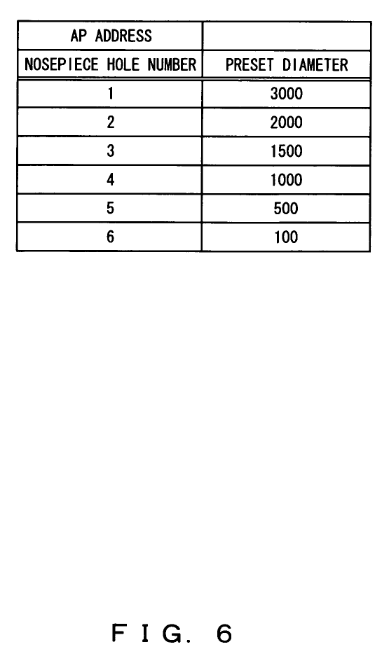

FIG. 6 shows an example of an AP preset diameter table in the first preferred embodiment.

At the AP address in the non-volatile memory 404, the AS preset diameter table as shown in FIG. 6 is put, and in its first and second columns, hole numbers and AS opening diameters, respectively, are stored. An observer can set the preset diameter from the setting unit 125.

Next, the operation in the first preferred embodiment of the microscope with the above-described structure is described.

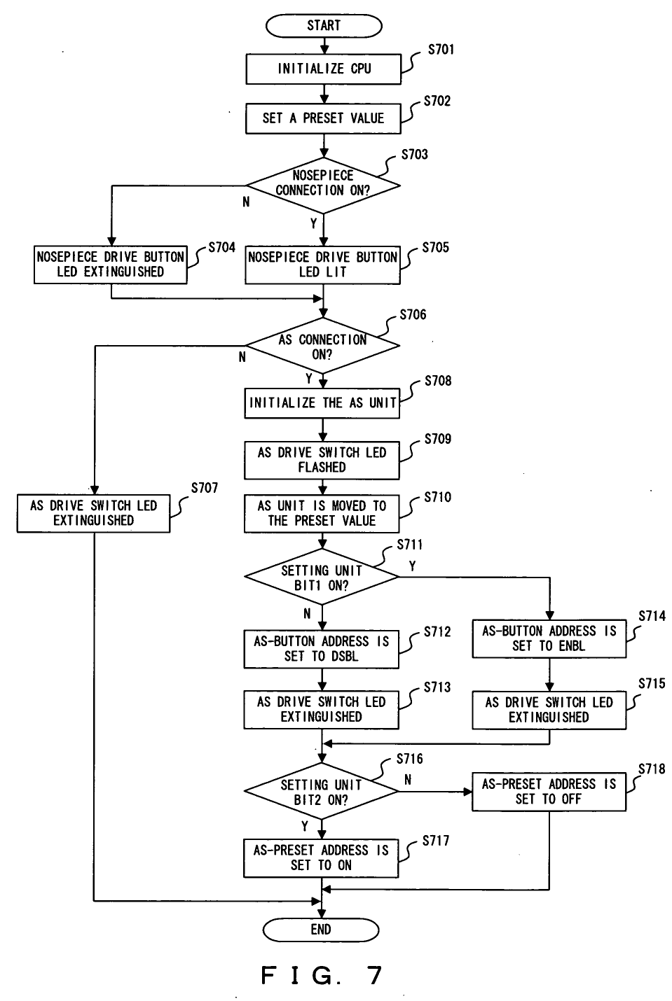

FIG. 7 is a flowchart showing the initialization process in the first preferred embodiment of the present invention.

Firstly, if the power of the microscope main body 1 is switched on, in step S701, the CPU 401 in the control unit 122 is initialized. In step S702, the setting values of the rotary switches 1502a through 1502f are read from the setting unit 125 and the AP addresses [1] through [6] of the non-volatile memory 404 shown in FIG. 6 are set.

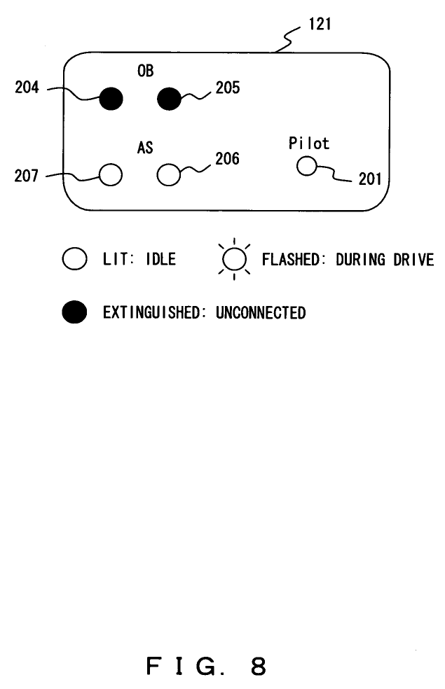

Then, in step S703, the state of the nosepiece connection sensor (whether the nosepiece sensor is connected) is checked. In this case, if the nosepiece connection sensor is off, specifically the nosepiece unit 104 is not connected (N in step S703), in step S704, a “L” signal is transmitted to the address unit of the nosepiece drive button group 202 of the front switch I/O 405a to extinguish the LED of the nosepiece drive button group 202. In this case, the state of the front switch 121 becomes as shown in FIG. 8 (nosepiece unconnected). If the nosepiece is on, specifically, the nosepiece unit 104 is connected (Y in step S703), in step S705, the LED of the nosepiece drive button group 202 is lit and the AS connection sensor is checked.

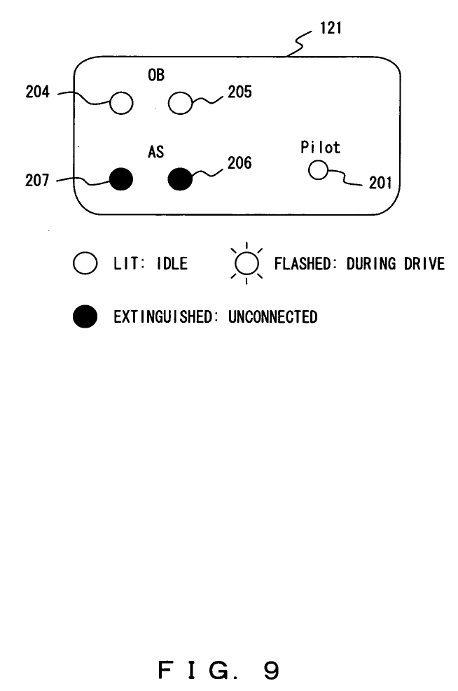

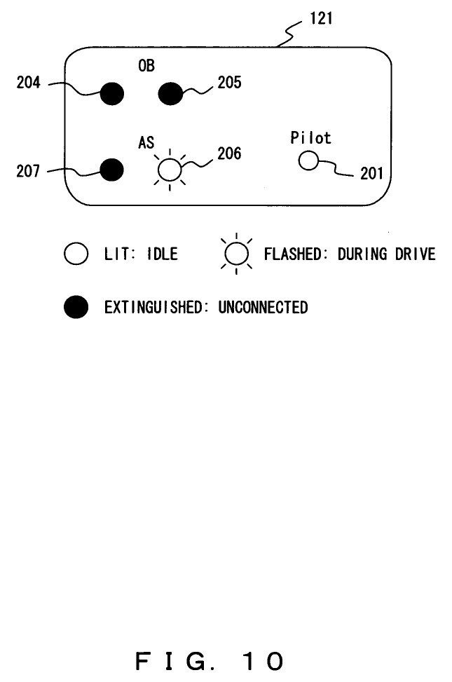

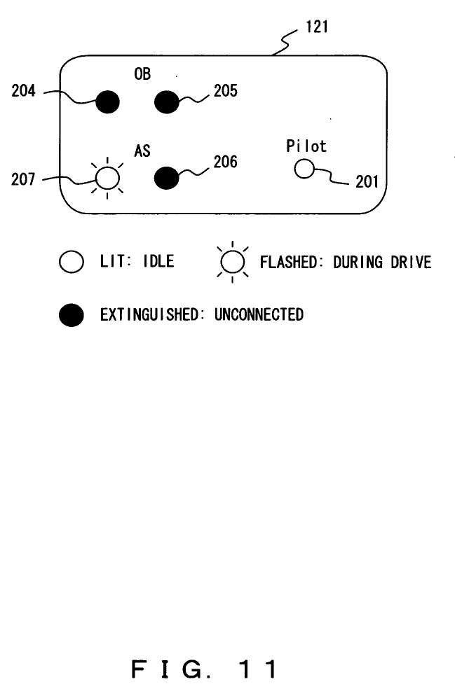

Then, in step S706, it is checked whether the AS connection sensor is on. If the AS connection is off (N in step S706), in step S707, the LED of the AS drive button 203 is made off and this initialization process is terminate. FIG. 9 shows the LED lighting pattern in this case. If the AS connection sensor is on (Y in step S706), in step S708, the origin initialization of the AS motor 111 is performed and in step S709, the LED of the AS drive button group 203 is lit in order to indicate the driving state of the AS. FIGS. 10 and 11 shows the LED lighting pattern in this case.

After the completion of the origin initialization, in step S710, an AS preset diameter corresponding to the current hole number from the AP addresses [1] through [6] of the AS preset table of the non-volatile memory 404 and the AS motor 118 is moved to the preset setting value.

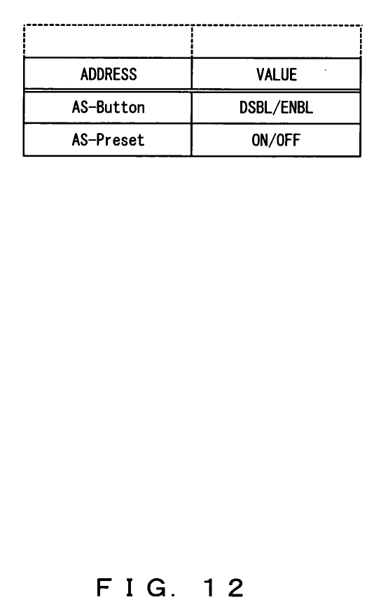

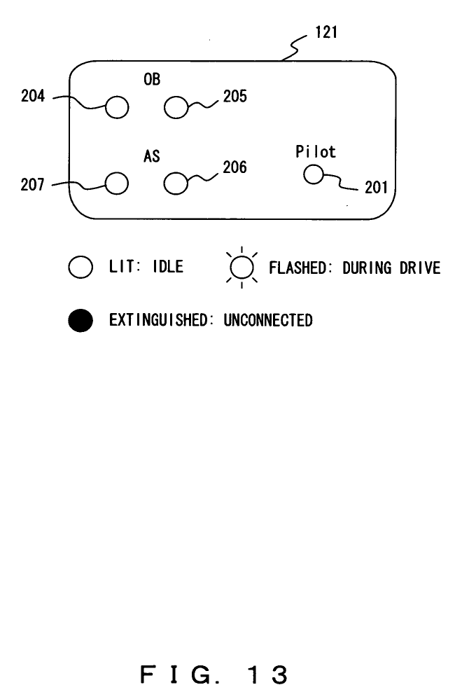

Then, in step S711, it is checked whether the setting state of the BIT1 of the piano switch 1501 of the setting unit 125 is on. If the setting state of BIT1 is off (N in step S711), the AS drive button group is set invalid. In this case, firstly, in step S712, the value of AS-Button address in the RAM 402 shown in FIG. 12 is set to DSBL (disable), and in step S713, the LED of the AS drive button group 203 is extinguished. If the setting state of BIT1 is on (Y in step S711), the AS drive button group 203 is set valid. In this case, firstly, in step S714, the value of AS-Button address is set to ENBL (enable), and in step S715, the LED of the AS drive button group 203 is lit. FIG. 13 shows the LED lighting pattern in this case.

Then, in step S716, the setting state of the BIT2 of the piano switch 1501 of the setting unit 125 is obtained and it is checked whether the obtained setting state of BIT2 is on. If the setting state of BIT2 is on (Yin step S716), the AS preset setting becomes valid. In this case, in step S717, ON is set to the AS-Preset address in the RAM 402 shown in FIG. 12 and this initialization process is terminated. If the setting state of BIT2 is off (N in step S716), in step S718, the AS preset setting becomes invalid. In this case, the AS-Preset address is set to OFF and this initialization process is terminated.

Next, as the description of the drive of the AS unit 111, the operation process in the case where the AS drive button group 202 is pushed is described.

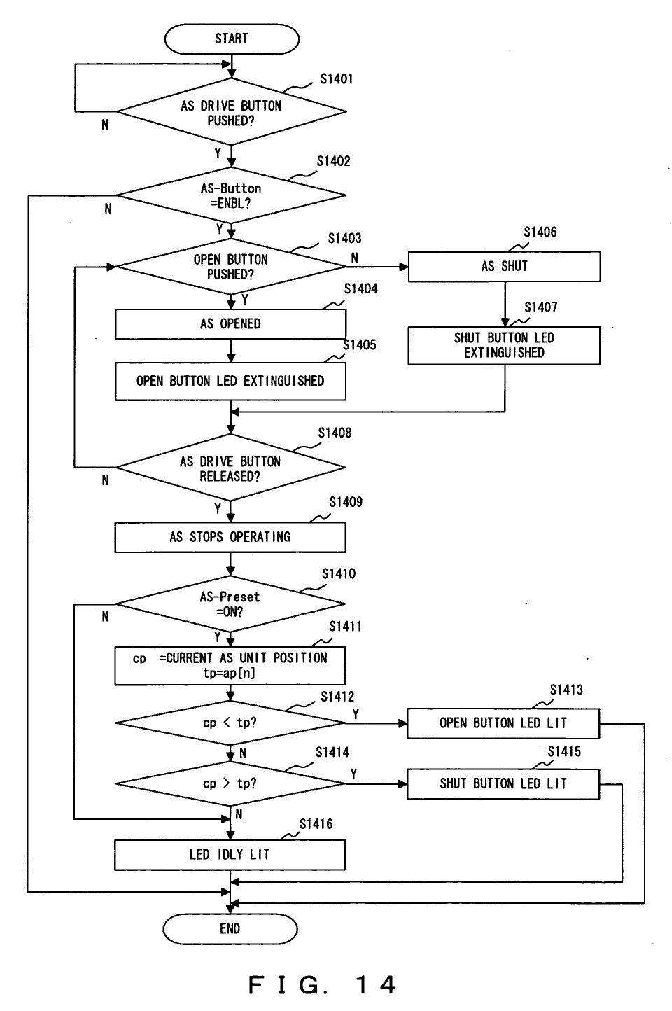

FIG. 14 is a flowchart showing the operation process in the case where the AS drive button group is pushed in the first preferred embodiment of the present invention.

Firstly, in step S1401, if it is determined that the AS open button 206 is pushed (Y in step S1401), in step S1402, it is checked whether the value of the AS-Button address in the RAM 202 is ENBL or DSBL. If the value of the AS-Button address is DSBL (N in step S1402), it means that the AS drive button group 203 is set invalid and this operation process in the case where the AS drive button group is pushed is terminated without doing anything. If the value of the AS-Button address is ENBL (Y in step S1402), the AS drive button group 203 is set valid, and in step S1403, the drive direction is checked (it is checked whether the drive direction is CW or CCW).

If the AS open button 206 is pushed (Y in step S1403), in step S1404, the aperture unit 112 is driven in the open direction and the LED of the AS open button 206 is flashed. If the shut button 207 is pushed (N in step S1403), in step S1406, the aperture unit 112 is driven in the shut direction and the LED of the AS shut button 207 is flashed. The aperture unit 112 is driven while the AS drive button group 203 is being pushed.

Then, when in step S1408 it is confirmed that the AS open button 206 is released (N in step S1408), in step S1409, the operation process of the aperture unit 112 is completed.

Then, in step S1410, the setting state of the preset of the setting unit 125 (whether the AS preset is ON) is checked referring to the AS-Preset address in the RAM 402. If the value in the AS-Preset address is OFF (N in step S1410), in step S1416, the LED is idly lit and this operation process in the case where the AS drive button group is pushed is terminated. If the value in the AS-Preset address is ON (Y in step S1410), in step S1411, the current position of the aperture unit 112 and the AS preset value are compared, the current position of the aperture unit 112 is read from the AS unit I/O 405b in order to indicate it by the AS drive button group 121 and the position is set in the cp address in the RAM 402, which is not shown in FIG. 5, (cp=current AS unit position). Then, an AS preset value corresponding to the current hole number is read from the non-volatile memory 404 and is set in the tp address in the RAM 402, which is not shown in FIG. 5, (tp=ap(n); n=current hole position).

Then, the sizes of tp and cp are compared. Specifically, in step S1412, it is determined whether tp is larger than cp. If cp<tp (Y in step S1412), in step S1413, only the LED of the open button 206 is lit and this operation process in the case where the AS drive button group is pushed is completed.

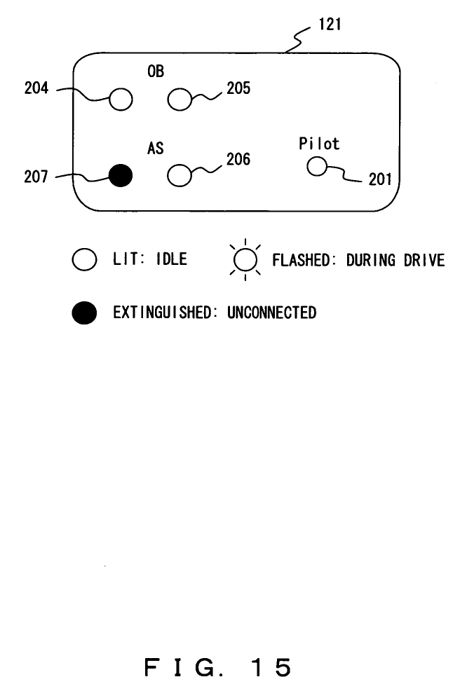

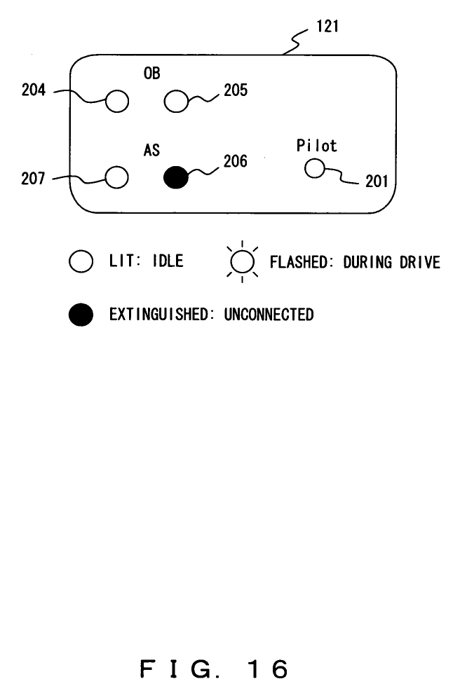

If in step S1414 it is determined whether cp is larger than tp and also cp>tp (Y in step S1414), in step S1415, only the LED of the shut button 207 is lit and this operation process in the case where the AS drive button group is pushed is completed. FIGS. 15 and 16 show the LED lighting pattern in this case.

If the present diameter=the current position, specifically, cp=tp (N in step S1414), in step S1416, the LED of the AS drive button is lit (idle codition) and this operation process in the case where the AS drive button group is pushed is completed.

Next, the drive of the nosepiece unit 104 is described.

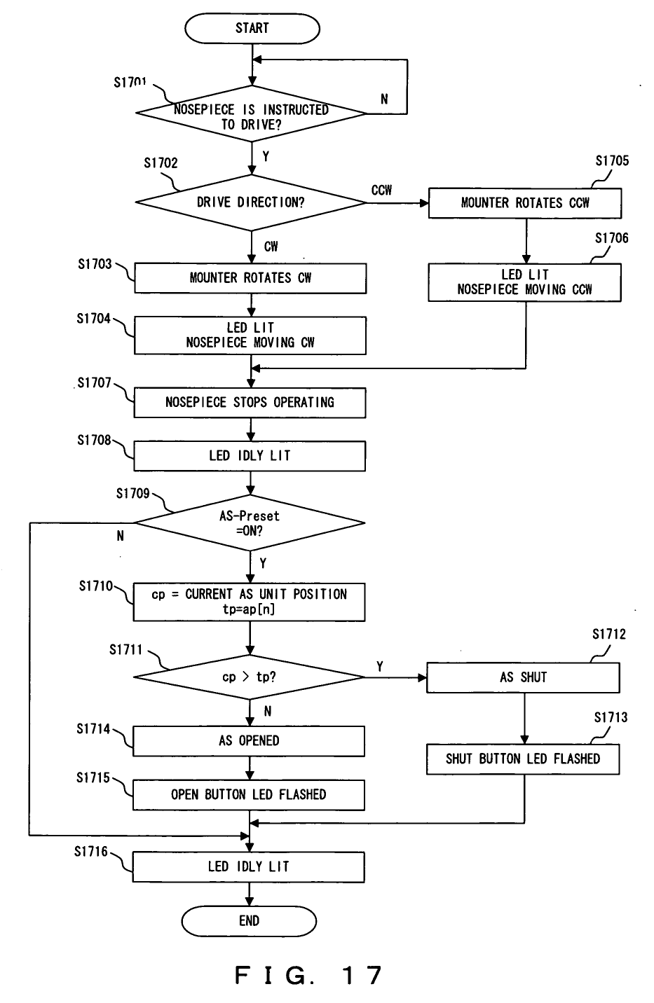

FIG. 17 is a flowchart showing the nosepiece driving process in the first preferred embodiment of the present invention.

Firstly, when in step S1701, it is determined that the nosepiece drive button group 202 is pushed (Y in step S1701), in step S1702, the drive direction (whether the drive direction is CW or CCW) is checked.

When in step S1702 it is determined, the mounter 106 in the determined drive direction is driven and the LED of the nosepiece drive button group 202 corresponding to the direction flashes. Specifically, if in step S1702 it is determined that the CW button 204 is pushed (CW in step S 1702), in step S1703, the mounter 106 rotates in the CW direction, and in step S1704, only the LED of the CW button 204 is lit. If in step S1702 it is determined that the CCW button 205 is pushed (CCW in step S1702), in step S1705, the mounter 106 is rotated in the CCW direction, and in step S1706, only the LED of the CCW button 205 is lit.

Then, when the movement completion sensor is turned on, in step S 1707, the operation of the mounter 106 is stopped, and in step S1708, the LED of the nosepiece drive button group 202 is idly lit.

Then, in step S1709, the setting state of the present of the setting unit 125 (whether the AS preset is ON) is checked referring to the AS-Preset address in the RAM 402. If the value in the AS-Preset address is OFF (N in step S1709), in step S1716, the LED is idly lit and this nosepiece driving process is completed. If the value in the AS-Preset address is ON (Y in step S1709), in step S1710, the current position of the aperture unit 112 and the AS preset value are compared, the current position of the aperture unit 112 is read from the AS unit I/O 405b in order to move the AS unit 111 to the preset position and the position is set in the cp address in the RAM 402, which is not shown in FIG. 5, (cp=current AS unit position). Then, an AS preset value corresponding to the current hole number is read from the non-volatile memory 404 and is set in the tp address in the RAM 402, which is not shown in FIG. 5, (tp=ap(n); n=current hole position).

Then, the sizes of tp and cp are compared. Specifically, in step S1711, it is determined whether cp is larger than tp. If cp>tp (Y in step S1711), in step S1712, the AS unit 111 is shut, and in step S1713, the LED of the shut button 207 is flashed. If cp>tp is not satisfied (N in step S1711), in step S1714, the AS unit 111 is opened and in step S1715, only the LED of the open button 206 is flashed.

Then, after the operation of the AS unit 111 is completed, in step S1716, the LED of the AS drive button group 203 is lit (idle condition) and this nosepiece driving process is completed.

By setting the AS drive button group 203 invalid by the piano switch 1501 of the setting unit 125 as in the above-described first preferred embodiment of the present invention, there is no need to move the microscope motorized unit when an observer pushes the operation unit by mistake, thereby preventing an error during observation.

Next, the second preferred embodiment of the present invention is described.

As to this second preferred embodiment, only parts different from the above-described first preferred embodiment are described.

The microscope in this second preferred embodiment differs from the above-described first preferred embodiment in that the microscope main body in the second preferred embodiment comprises a front switch group 121A instead of the front switch group 121.

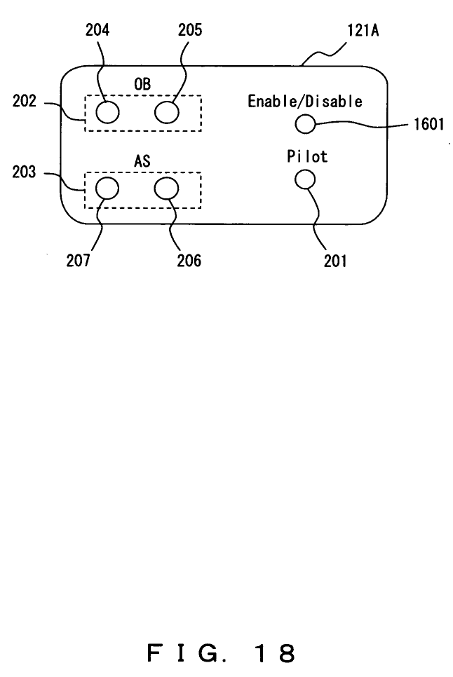

FIG. 18 shows the configuration of the front switch group in the second preferred embodiment.

In FIG. 18, like the front switch group 121 in the first preferred embodiment, the front switch group 121A comprises a pilot lamp 201 for indicating the on state of the microscope main body, a nosepiece drive button group 202 composed of a CW button 204 for rotating the mounter 106 of the nosepiece unit in the CW direction and a CCW button 205 for rotating it in the CCW direction, an AS drive button group 203 composed of an open button 206 for opening the aperture unit 112 of the AS unit 111 and a shut button 297 for shutting it and a setting button 1601 for switching between the valid/invalid of the AS drive button group 203. The setting button 1601 is formed into one package composed of the switch 301 and LED 302 shown in FIG. 4, like the AS drive button group 203 and the nosepiece drive button group 202.

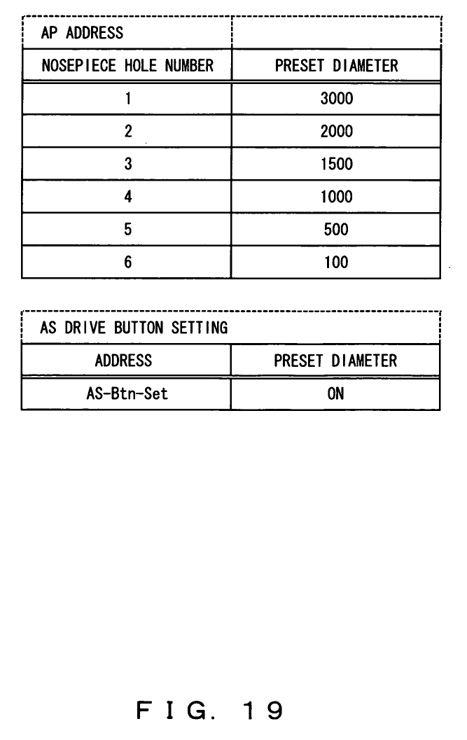

In the non-volatile memory 404 of the control unit 122, as shown in FIG. 19, the setting information up to the previous time of the AS drive button group 203 is stored in the AS-Btn-Set address. If its value is ON, it indicates that the AS drive button group 203 is valid. Conversely, if the value is OFF, it indicates that the AS drive button group 203. These values are written in the nonvolatile memory even after the power is switched off.

Next, the operation in the second preferred embodiment of the microscope with the above-described configuration is described.

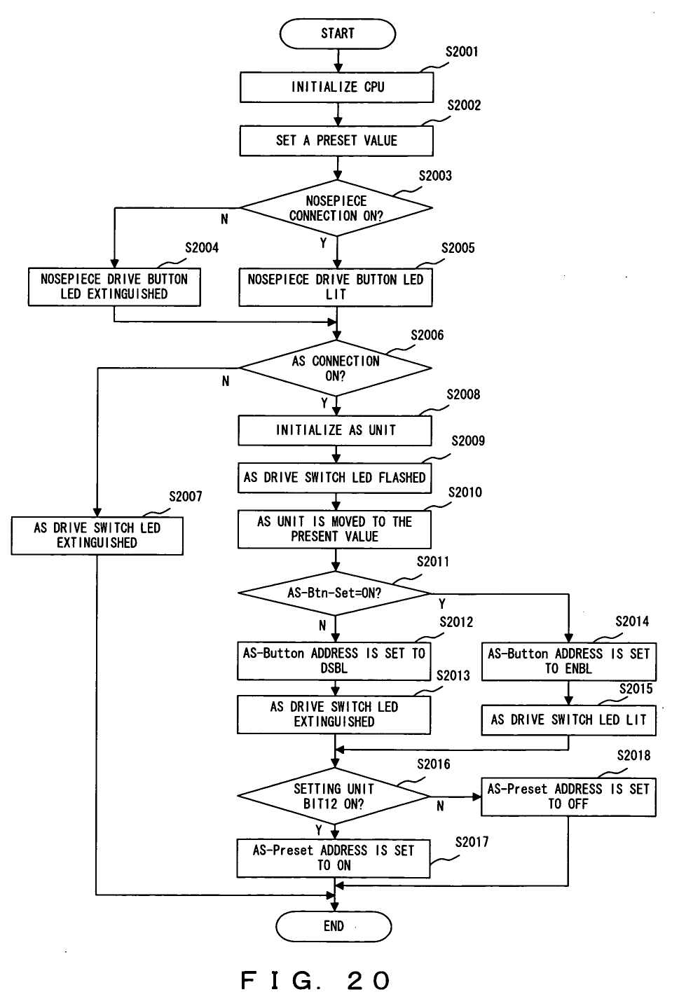

FIG. 20 is a flowchart showing the initialization process in the second preferred embodiment of the present invention.

Firstly, when the power of the microscope main body is switched on, in step S2001, the CPU 401 in the control unit 122 is initialized. In step S2002, the setting values of the rotary switches 1502a through 1502f are read from the setting unit 125 and are set in the AP addresses [1] through [6] in the non-volatile memory 404 shown in FIG. 6.

Then, in step S2003, the state of the nosepiece connection sensor (whether the nosepiece sensor is connected) is checked. If the nosepiece connection sensor is off, specifically, the nosepiece unit 104 is not connected (N in step S2003), in step S2004, an “L” signal is transmitted to the address unit of the nosepiece drive button group 202 of the front switch I/O 405a and the LED of the nosepiece drive button group 202 is extinguished. If the nosepiece sensor is on, specifically the nosepiece unit 104 is not connected (Y in step S2003), in step S2005, the LED of the nosepiece drive button group 202 is lit and the AS connection sensor is checked.

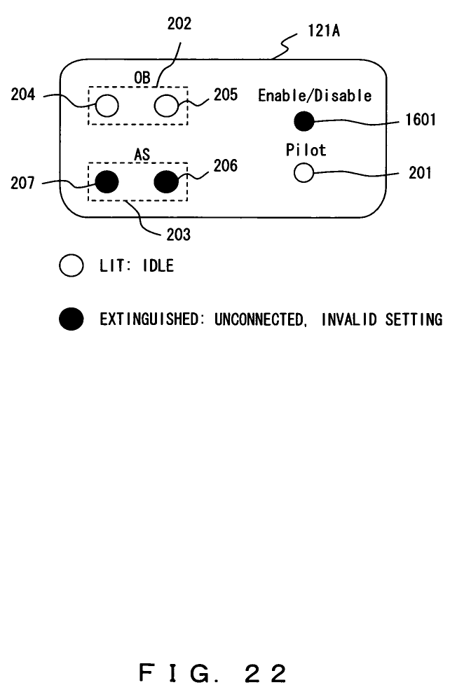

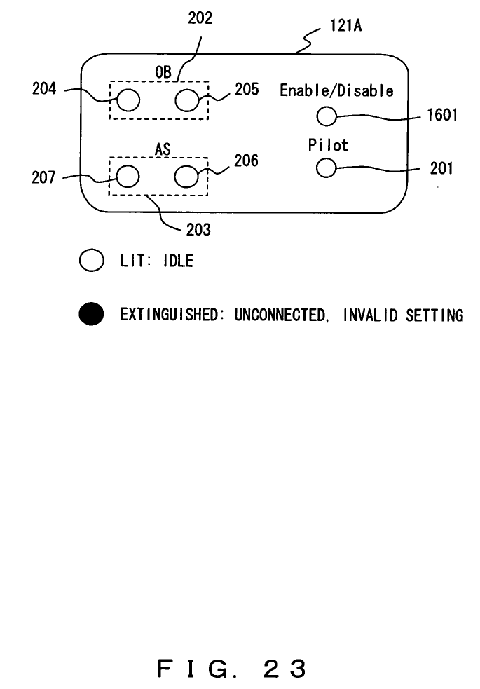

Then, in step S2006, it is checked whether the AS connection sensor is on. In this case, if the AS connection sensor is off (N in step S2006), in step S2007, the LED of the AS drive button 203 is turned off and this initialization process is completed. FIG. 22 shows the LED lighting pattern in this case. If The AS connection sensor is on (Y in step S2006), in step S2008, the origin initialization of the AS motor 118 is performed and in step S2009, the LED of the AS drive button group 203 for indicating the driving state of the AS is flashed. FIG. 23 shows the LED lighting pattern in this case.

Then, after the completion of the origin initialization, in step S 2010, an AS preset diameter corresponding to the current hole number is read from the AP addresses [1] through [6] of the AS preset table of the non-volatile memory 404 and the AS motor 118 is moved to the present value.

Then, in step S2011, the value of the AS-Btn-Set address of the non-volatile memory 404 is read in order to obtain the previous information of the AS drive button group 203, and it is checked whether the value of the AS-Btn-Set address is ON. If the value of the AS-Btn-Set address is OFF (N in step S2011), the AS drive button group 203 is set invalid. Firstly, in step S2012, the value of the AS-Button address in the RAM 402 shown in FIG. 12 is set to DSBL (disable), and in step S 2013, the LED of the AS drive button group 203 is extinguished (see FIG. 22). If the value of the AS-Btn-Set address is ON (Y in step S2011), the AS drive button group 203 is set valid. In this case, firstly, in step S 2014, the value of the AS-Button address is set to ENBL (enable), and in step S2015, the LED of the AS drive button group 203 is lit (see FIG. 23).

Then, in step S2016, the setting state of the BIT2 of the piano switch 1501 of the setting unit 125 is obtained, and it is checked whether the obtained setting state of the BIT2 is on. If the setting state of the BIT2 is on (Y in step S2016), the AS preset setting becomes valid, and in step S2017, ON is set to the AS-Preset address in the RAM 402 shown in FIG. 12 and this initialization process is completed. If the setting state of the BIT2 is off (N in step S2016), in step S2018, the AS preset setting becomes invalid and OFF is set to the AS-Preset address and this initialization process is completed,

Next, the operation in the case where the setting button 1601 is pushed is described.

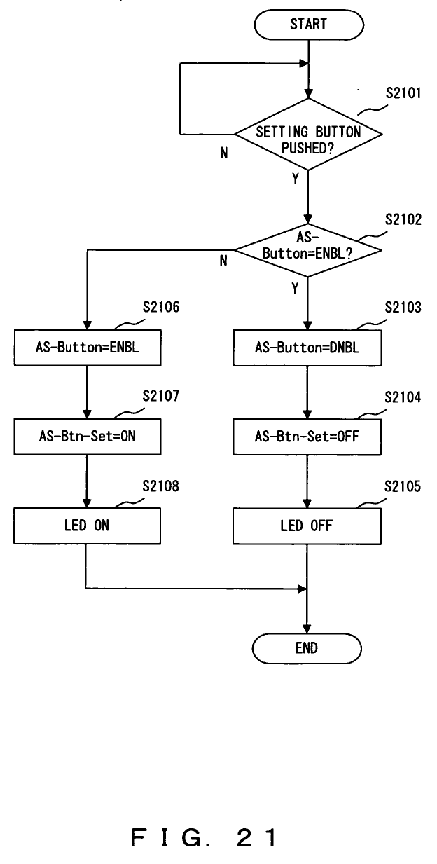

FIG. 21 is a flowchart showing the operation process in the case where the setting button group is pushed in the second preferred embodiment of the present invention.

Firstly, in step S2101, when it is determined that the setting button 1601 is pushed (Y in step S2101), in step S2102, in order to check the current valid/invalid setting of the AS drive button 203 it is checked whether the value of the AS-Button address in the RAM 402 is ENBL or DSBL. If the value of the AS-Button address is ENBL (Y in step S1402), in step S2103, the AS-Button address is set to DSBL in order to invalidate the setting of the AS drive button 203, and also in step S2104, the AS-Btn-Set address in the non-volatile memory 404 is turned off. Furthermore, in step S2105, the LEDs of the AS drive button group 203 and setting button 1601 are tuned off (see FIG. 22), and this operation process in the case where the setting button is pushed is completed. If the value of the AS-Button address is not ENBL, that is, is DSBL (N in step S1402), in step S2106, the AS-Button address is set to ENBL in order to validate the setting of the AS drive button 203, and also in step S2107, the AS-Btn-Set address in the non-volatile memory 404 is tuned to ON. Furthermore, in step S2108, the LEDs of the AS drive button group 203 and setting button 1601 is turned on (see FIG. 23), and this operation process in the case where the setting button group is pushed.

In the above-described second preferred embodiment of the present invention, besides the effect of the first preferred embodiment, an observer can set the valid/invalid of the AS drive button 203 in the state where the power is on, by providing the setting button 1601.

In the above-described first and second preferred embodiment, the setting unit for setting a function to control the motorized drive unit can assign at least one function to control the motorized drive unit, and the functions to be set by the setting unit can be switched from outside the microscope main body.

The operation of the motorized drive unit can be switched by the operation switch from outside the microscope main body.

Although so far the preferred embodiments of the present invention have been described with reference to the drawings, the application of the microscope adopting the present invention is not limited to the above-described preferred embodiments and the microscope can be used as a stand-alone device, or be used in a system or incorporated device composed of a plurality of devices or a system where processing is performed via a network, such as LAN, WAN or the like as long as the function can be executed.

The function of each above-described preferred embodiment can also be realized in a system comprising a CPU, memory, such as ROM or RAM, an input device, an output device, an external storage device, a medium driving device, a portable storage medium, a network connection device which are connected by a bus. Specifically, a software program code for realizing each of the above-described preferred embodiment which is recorded on memory, such as ROM or RAM, an external storage device or a portable storage medium to is provided to the microscope, and by the computer of the microscope reading and executing the program code, the system can also be realized.

In this case, the program code read from the portable storage medium or the like realizes the new function of the present invention, and the portable storage medium or the like on which the program code is recorded also constitutes the present invention.

For the portable storage medium for providing the program code, a flexible disk, a hard disk, an optical disk, a magneto-optical disk, CD-ROM, CD-R, DVD-ROM, DVD-RAM, a magnetic tape, a non-volatile memory card, a ROM card, a variety of storage media on which the program code is recorded by e-mail, personal computer communication or the like, via a network connection device and the like can be used.

Besides the fact that the function of each above-described preferred embodiment can be realized by executing the program code that a computer reads onto memory, by an OS or the like which operates on a computer performing a part of or all an actual process, according to the instruction of the program code, the function of each above-described preferred embodiment can also be realized.

Furthermore, by a CPU provided for a function extension board inserted in a computer or function extension unit connected o a computer performing a part of or all an actual process, according to the instruction of the program code after a program code read from a portable storage medium or a program (data) provided by a program (data) provider is written onto memory provided for the function extension board or unit, the function of each above-described preferred embodiment can also be realized.

Although in each preferred embodiment, only an AS has been described, instead of an AS, a nosepiece, an observation method switch, an X-Y stage, a Z stage, an AF, a filter turret, a shutter, a FS, a condenser lens, a DIC prism or a light control can also be used. However, in that case, an operation button for it must be provided for each motorized drive unit. Alternatively, only one operation button can be switched to operate a plurality of electric units.

Although an operation unit being one package composed of a LED and a switch is used in each preferred embodiment, they can also be discrete components. An observer can know the setting state of the microscope by checking the state of the piano switch 1501, and no special LED is needed.

Although in each preferred embodiment, the operation unit only using the front switch group 121 has been described, a hand switch which is connected to a microscope and can be remotely controlled can also be used. In this case, a hand switch I/O is also needed.

Although in each preferred embodiment, the valid/invalid of the operation unit is switched by the piano switch 1501 of the setting unit 125, the motorized drive unit assigned to each switch can also be switched. For example, if one BIT of the piano switch is on, the nosepiece drive button group 202 of the front switch group 121 instruct the drive of the nosepiece unit 104 and the AS drive button group 203 instructs the drive of the AS unit 111. If one BIT of the piano switch is off, the nosepiece drive button group 202 instructs the drive of the AS unit 111 and the AS drive group 203 instructs the drive of the nosepiece unit 104.

Although in each preferred embodiment, for the setting unit 125 the piano switch 1501 and the rotary switches 1502a through 1502f are used, a lever switch, a seesaw switch, a toggle switch, a slide switch or a push switch or the like can also be used instead of them.

Although in each preferred embodiment, each operation has been explained using a flowchart, its detailed order or items of the flow are not limited to it.

Although in the first preferred embodiment, the valid/invalid of the AS drive button group 203 is set by the piano switch 1501 of the setting unit 125, it is not limited to this. For example, power can also be switched on and set while pushing an arbitrary button of the front switch group 121.

Although in the second preferred embodiment, the valid/invalid of the AS drive button group 203 is set by the setting button 1601, it is not limited to this. For example, it can also be set by simultaneously pushing two arbitrary buttons of the front switch group 121.

In other words, the present invention is not limited to the above-described preferred embodiments, and it also can take a variety of configurations or forms as long as the subject matter of the present invention is not deviated.

According to the present invention, even if an observer pushes the operation unit by mistake in a microscope using at least one or more motorized units without using an expensive PC system and a LC display unit, neither motorized unit will be driven nor there will be any observation error.

What is claimed is:

1. A microscope, comprising:
at least one or more motorized drive units;
an operation unit with at least one or more operation switches for operating the motorized drive units;
a control unit for controlling the motorized drive units; and
a setting unit in which the control unit can switch the setting of a function to control the motorized drive units.

2. The microscope according to claim 1, wherein
the setting unit can assign at least one function to control the motorized drive unit.

3. The microscope according to claim 1, wherein
the functions set by the setting unit can be switched from outside the microscope main body.

4. The microscope according to claim 1, wherein
the function set by the setting unit is a function to validate or invalidate the operation of the operation unit.

5. The microscope according to claim 1, further comprising
a light emission unit for emitting light, according to a function set by the setting unit in accordance with the operation switch.

6. The microscope according to claim 4, further comprising
a light emmission unit for emitting light in accordance with the operation switch, wherein
the light emission unit differently lights a light emitting pattern of the operation unit, set invalid by the setting unit and a light emitting pattern set valid.

7. The microscope according to claim 1, wherein
the function set by the operation unit is a function to drive the motorized drive unit operated by the operation unit.

8. The microscope according to claim 1, wherein
the motorized drive unit drives at least one of a nosepiece, an aperture stop (AS), an observation method switch, an X-Y stage, a Z stage, an auto-focus (AF), a filer turret, a shutter, a field stop (FS), a condenser lens, a differential interference contrast (DIC) prism and a light control.

9. The microscope according to claim 1, wherein
the setting unit is at least one of a piano switch, a rotary switch, a button switch, a lever switch, a toggle switch, a slide switch and a seesaw switch.

10. The microscope according to claim 1, wherein
the operation unit is provided for the microscope main body.

11. A microscope, comprising:
at least one or more motorized drive units;
an operation unit with at least one or more operation switches for operating the motorized drive units; and
a control unit for controlling the motorized drive units, wherein
the function set by the setting unit is a function to validate or invalidate the operation of the operation unit.

12. The microscope according to claim 1, wherein
the operation can be switched from outside the microscope main body.

13. The microscope according to claim 8, further comprising
a light emission unit for differently lighting a light emitting pattern according to whether the operation switch is switched valid or invalid by the operation unit.

14. The microscope according to claim 8, wherein
the motorized drive unit drives at least one of a nosepiece, an aperture stop (AS), an observation method switch, an X-Y stage, a Z stage, an auto-focus (AF), a filer turret, a shutter, a field stop (AS), a condenser lens, a differential interference contrast (DIC) prism and a light control.

15. A control method for controlling a microscope comprising at least one motorized drive unit and an operation unit with at least one operation switch for operating the motorized drive unit, comprising
switching between a function to validate the operation of the operation unit and a function to invalidate the operation.
